(19) United States
(12) Patent Application Publication
(10) Pub. No.: US 2016/0354957 A1
(43) Pub. Date: Dec. 8, 2016

(54) METHOD FOR INJECTING A TANK WALL COMPRISING A LOCALISED REINFORCING LAYER

(71) Applicant: PLASTIC OMNIUM ADVANCED INNOVATION AND RESEARCH, Bruxelles (BE)

(72) Inventors: Wilfried LEMASSON, Brussels (BE); Frederic GUINGNERY, Mery-sur-Oise (FR); Pierre DE KEYZER, Brussells (BE); Jules-Joseph VAN SCHAFTINGEN, Waver (BE)

(21) Appl. No.: 15/108,956

(22) PCT Filed: Dec. 26, 2014
(86) PCT No.: PCT/FR14/53563

§ 371 Date: Jun. 29, 2016

(30) Foreign Application Priority Data
Dec. 30, 2013 (FR) 1363678

(51) Int. Cl. B29C 45/14; B29C 33/12

(52) U.S. Cl. CPC B29C 45/14786; B29C 45/14073; B29C 45/14336; B29C 33/123; B29L 2031/7172

(57) ABSTRACT

A method for producing a wall intended, for example, to form the wall of a tank, by pressure injecting a thermoplastic material into an injection mould, said wall comprising at least one localised reinforcing layer formed from reinforcing threads coated with a thermoplastic material compatible with the thermoplastic material forming said wall. The reinforcing layer is deposited in the injection mould at a temperature substantially equal to the ambient temperature of a workshop, and the injection temperature of the thermoplastic material forming the wall, the melting temperature of the thermoplastic material coating the reinforcing threads and the thickness of the reinforcing layer are adjusted such that the material coating the reinforcing threads is melted during the injection phase.

The present invention relates to processes for manufacturing articles having thin walls and requiring localized reinforcements. More particularly, the invention relates to an injection molding process for manufacturing tanks intended for equipping motor vehicles.

The manufacture of tanks by thermomolding is widely known in the industry and, conventionally, is carried out in a single operation during which, successively, a cylindrical web of thermoplastic material, forming a parison, is produced by injection, a mold is closed around said still hot and plastic parison, and a pressurized gas is injected so as to press the parison against the walls of the mold.

Alternatively, it is also possible to produce the walls of the tank by thermoforming in a mold.

It may prove necessary, depending on the function of the tank, to provide localized reinforcements in order to absorb local stresses linked for example to the internal pressure prevailing in the tank, or else to the method of attachment and to the load represented by the liquids that the tank is intended to contain.

These localized reinforcements are then in the form of fabrics formed of oriented or non-oriented reinforcing fibers or yarns and impregnated with a thermoplastic material capable of fusing with the material forming the tank. The reinforcing fibers may be of synthetic, natural or metal origin.

The insertion of a localized reinforcement may take place, according to a first method, by applying the reinforcement to the outer wall of the tank after the tank has been removed from the mold and cooled. The reinforcement is brought to a temperature close to the melting point of the thermoplastic material that forms it, then is applied under pressure to the previously preheated wall of the tank.

According to a second method, when use is made of a device for blow molding a parison in a mold, the insertion of localized reinforcements takes place before the parison is introduced into the mold. The reinforcement is previously brought to a temperature close to the melting point of the material impregnating the yarns that form it, and, with the aid of a suitable device, is placed on the outer surface of the parison or directly in the mold in the region intended to form the part of the tank requiring a particular reinforcement. For this operation to be successful, it is particularly important to keep the thermoplastic materials of the reinforcement in a plastic state and at a temperature close to their melting point in order to facilitate the adhesion with the material forming the parison, and in order to avoid the shrinkage phenomena capable of locally impeding the shaping and molding of the walls of the tank. This method is very suitable for the production of large-capacity tanks that withstand high loads and that require thick reinforcements.

Although they have been well proven, these methods require onerous and difficult processing if it is desired to obtain perfect fusion of the reinforcement and of the material forming the walls of the tank. Indeed, the handling of the hot and plastic reinforcement requires precautions to be taken for preventing geometric deformations of the reinforcement itself while limiting the cooling thereof.

However, under certain conditions, it proves possible to produce a tank as two separate parts that are joined by welding to form a sealed chamber intended to receive a given liquid product.

These two, or more, parts may then usefully be produced by injecting a thermoplastic material into a mold designed for this purpose. This embodiment makes it possible, among other things, to manufacture relatively low cost tanks.

The invention proposes to provide a particularly economical solution for producing a wall, intended for example to form the wall of a tank, by injection, under pressure and at a predetermined temperature, of a thermoplastic material into a mold, said wall comprising at least one localized reinforcing sheet of predetermined thickness formed from reinforcing yarns coated with a thermoplastic material that is compatible with the thermoplastic material forming said wall and having a predetermined melting point.

The process according to the invention is characterized in that the reinforcing sheet is deposited in the injection mold at a temperature substantially equal to the ambient temperature of a workshop and that the injection temperature of the thermoplastic material forming the wall, the melting point of the thermoplastic material coating the reinforcing yarns and the thickness of the reinforcing sheet are adjusted so that the material coating the reinforcing yarns is melted during the injection phase.

It is then no longer necessary to preheat the reinforcing sheet before introducing it into the mold, which makes it possible to simplify the process for producing the wall, and to reduce the production cost thereof. Furthermore, in the absence of deformations of the reinforcing sheet during the molding, the process makes it possible to avoid all movements of material in the mold.

The process according to the invention may also comprise multiple modes of implementation that make it possible to optimize the performance of the final product, the features of which, taken individually or in combination, are the following:
The temperature of the workshop is between 15° C. and 30° C.
The thermoplastic material forming the wall and the thermoplastic material coating the reinforcing yarns are chosen from materials such as HDPEs, polyamides or polyphthalamides.
The reinforcing sheet comprises entangled reinforcing yarns.
The reinforcing sheet comprises one or more sheets of reinforcing yarns, each sheet of reinforcing yarns being composed of reinforcing yarns that are parallel to one another, and the sheets of reinforcing yarns being positioned so that the reinforcing yarns of one sheet form, with the reinforcing yarns of the other sheets, determined and non-zero angles.
The reinforcing sheet comprises woven reinforcing yarns.
The thickness of the reinforcing sheet is less than or equal to 0.7 mm, and preferably less than or equal to 0.5 mm.
The reinforcing yarns are embedded between two thermoplastic material films, so that the thickness of the thermoplastic material at the back of the reinforcing yarns is less than or equal to 0.2 mm, and preferably less than or equal to 0.05 mm.
The difference between the melting point of the thermoplastic material coating the reinforcing yarns of the reinforcing sheet and the injection temperature of the thermoplastic material forming said wall is between 60° C. and 115° C.
The injection temperature of the thermoplastic material forming said wall is between 190° C. and 330° C.
A hold time, under pressure, of the material in the mold is greater than 0.3 minute and preferably greater than 0.5 minute.
A temperature of the mold during the introduction of the reinforcing sheet is between 30° C. and 140° C.
The reinforcing sheet is preformed, to the final shape that it is desired to give it in the mold, prior to the introduction thereof into the mold.
The reinforcing sheet is anchored at a pre-established position in the mold with the aid of a plurality of retractable needles and/or blocks, able to be withdrawn at the end of the phase of injecting the material forming said wall.
A height of the needles and/or blocks is adjusted, so as to position the reinforcing sheet at predefined non-zero distances from the walls of the mold.

The invention will be better understood on reading the appended figures, which are provided by way of examples and have no limiting nature, in which:

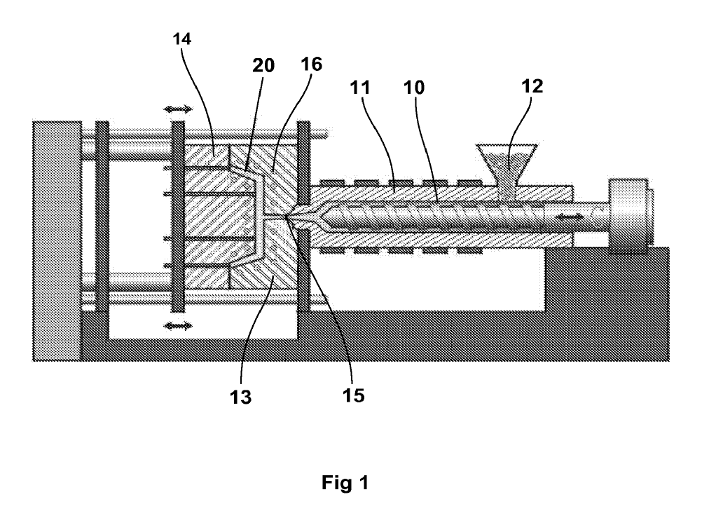

FIG. 1 represents a general and schematic view of an injection press.

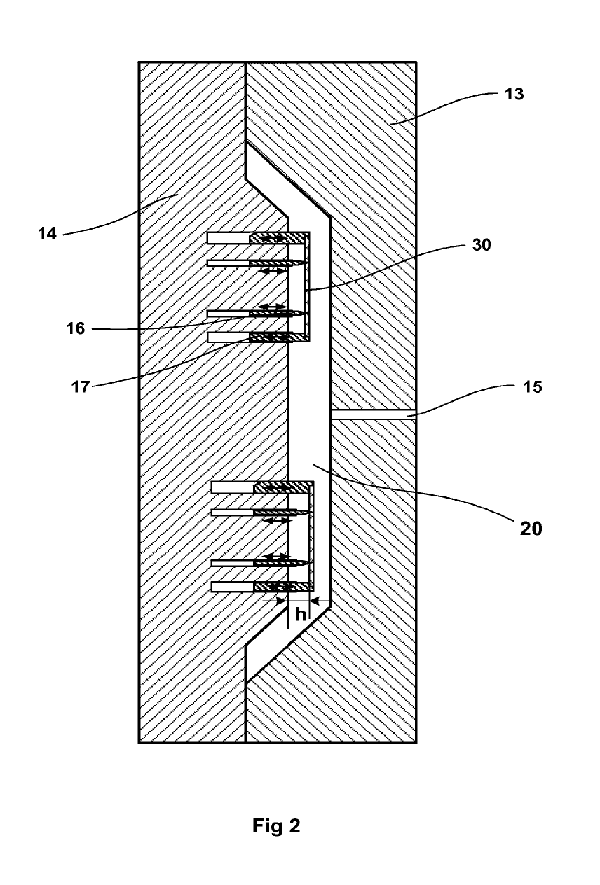

FIG. 2 represents a schematic cross-sectional view of the stationary part and the movable part of the injection mold comprising means for positioning the reinforcing sheet.

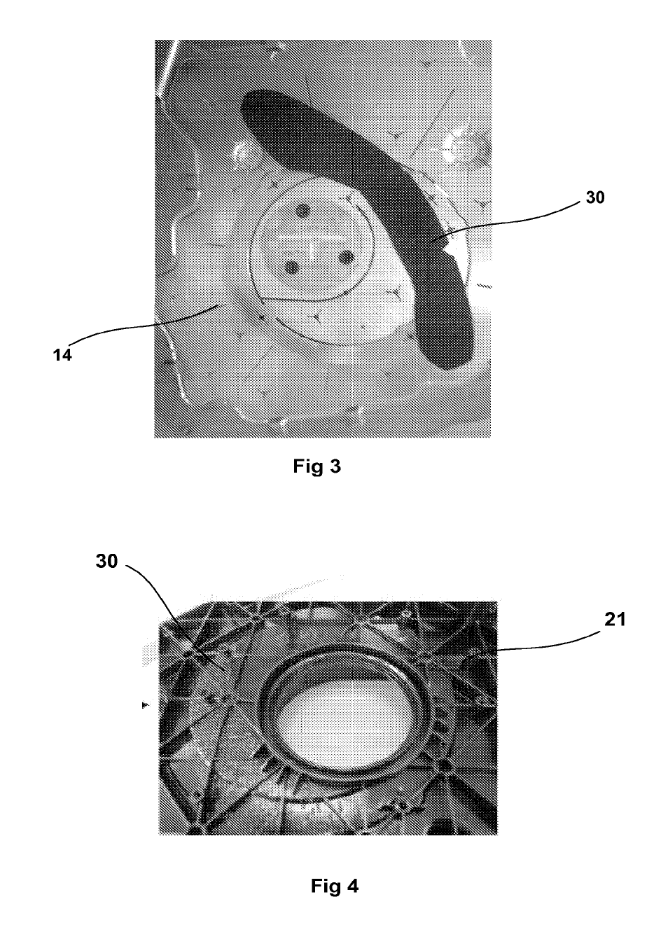

FIG. 3 represents the stationary platen of a mold in which a reinforcing sheet has been positioned before the closure of the mold.

FIG. 4 represents a perspective view of the wall of the base of a tank, comprising a reinforcing sheet, and obtained with the aid of the process according to the invention.

FIG. 1 represents an injection press 1 of standard type comprising an injection screw 10 rotatably mounted in a heated barrel 11. Positioned upstream of the screw is a receptacle 12 into which the granules of material to be injected are introduced. The screw opens, by means of an injection nozzle 15, into an injection mold comprising a stationary platen 13 and a movable platen 14, the internal space of which defines the shape and the volume of the part 20 to be injected at high temperature. Cooling circuits 16 are provided in the stationary platen and the movable platen in order to reduce the temperature of the material after the injection phase so as to enable the solidification thereof, before it is extracted, and just after the opening of the mold by translational movement of the movable platen 14.

This device makes it possible to produce high-quality thermoplastic material parts with a high yield. It proves to be particularly suitable for the production of medium- or small-size tanks, that will be produced by injection molding of two separate parts that are intended to be joined, for example by thermowelding, in order to form the final tank.

According to the invention, the tank is made of thermoplastic material. The term “thermoplastic material” denotes any thermoplastic polymer, including thermoplastic elastomers, and mixtures thereof. The term “polymer” denotes both homopolymers and copolymers (binary or ternary copolymers in particular). Examples of such copolymers are, nonlimitingly: random copolymers, sequential copolymers, block copolymers and graft copolymers.

Any type of thermoplastic polymer or copolymer, the melting point of which is below the decomposition temperature, is suitable. Synthetic thermoplastic materials that have a melting range spread over at least 10 degrees Celsius are very particularly suitable. Examples of such materials include those which have a polydispersion of their molecular weight.

In particular, use may be made of polyolefins, thermoplastic polyesters, polyketones, polyvinyls, halogenated polyvinyls such as polyvinyl chloride (PVC) or polyvinyl fluoride (PVDH), polyamides (PA) and copolymers thereof. A mixture of polymers or copolymers may also be used, and also a mixture of polymeric materials with inorganic, organic and/or natural fillers such as, for example, but nonlimitingly: carbon, clays, salts and other inorganic derivatives, natural or polymeric fibers.

These materials may contain additives such as stabilizing products, reinforcing fillers or plasticizing products.

One polymer that is often used is polyethylene (PE). Excellent results have been obtained with high-density polyethylene (HDPE) due to its chemical inertness and its good mechanical strength.

Although the capacity of this type of tank is smaller, it may prove necessary to make provision for the reinforcement of certain regions of the tank, generally the tank base located in the bottom part, so as to withstand the forces linked to its method of anchoring to the support intended to receive it. A small capacity is understood here to mean tanks whose capacity does not exceed around 20 liters.

The reinforcing sheet is in the form of reinforcing fibers or else yams coated with a thermoplastic material also referred to as a prepreg.

Depending on the desired mechanical strength, and on the nature of the stresses, the reinforcing yarns or fibers of the prepreg may be of synthetic, natural or metal origin.

The prepreg is an alternative to the reinforcements or fabrics that are referred to as dry, comprising no coating material and formed of synthetic or natural fibers or else of metal strands.

The reinforcement may be in numerous forms; it is generally a sheet comprising cut fibers or long fibers or continuous fibers that may or may not be woven. Generally, the cut fibers have final lengths of several tens/hundreds of microns. For the long fibers, the residual lengths are of several millimeters. Reference is made to continuous fibers or continuous filaments in the case where the length of the fibers used is of several centimeters.

When it is desired to reinforce the structure in several favored directions, it is then possible to superpose several sheets of yarns positioned so that the yarns of one sheet form, with the yarns of the other sheets, determined and non-zero angles. The sheets of yarns may be simply superposed one on top of the other, or else comprise weft yams and warp yarns in the manner of a fabric. The woven reinforcing sheets most commonly used are formed of two layers of yarns that are woven together.

Continuous fibers are however preferred and in particular nonwoven, randomly distributed continuous fibers (referred to as multidirectional fibers). While being less expensive than woven long fibers, these have the advantage of distributing the stresses more uniformly. They also have the advantage, within the context of the invention, of having a lower density of fibers, that is to say a higher proportion of voids which are advantageously filled with coating thermoplastic material in order to facilitate the welding.

The content of fibers in the reinforcement is preferably at least 30%, preferably at least 60% or even at least 45% of the total weight of the prepreg.

These fibers may be based on glass, carbon, a polymer (such as a polyamide, for example an aromatic polyamide such as an aramid), or may even be natural fibers, such as hemp or sisal. They are preferably glass fibers (of E-glass, S-glass or other type of glass). The fibers of the fibrous reinforcement according to the invention are preferably compatible with the thermoplastic material and therefore, as a general rule, compatible with polyolefins and in particular with HDPE. In order to obtain this compatibility, it is possible to size (surface treat) the fibers with a compatibilizing substance such as a silane. A reactive HDPE-type binder may also be used. Within this context, reactive functions of maleic anhydride type may advantageously be used.

According to the invention, the fibrous reinforcement comprises a thermoplastic material that is compatible with that of the tank, or even identical thereto. In the case of fuel tanks, this is generally polyethylene and in particular HDPE.

The thermoplastic material is preferably melted around/in the mass of fibers so as to form a homogeneous sheet/slab having, on at least one part of its surface, thermoplastic material so as to facilitate the welding. In practice, this may be carried out by compression molding, injection molding, spray molding, vacuum molding or else calendering. Preferably, the process for producing the reinforcement will be compression molding (continuous process by pressing between 2 rolls) or spray molding. Prepregs reinforced by woven continuous fibers give good results with this method.

According to one particularly preferred variant, the reinforcement covers at least one portion of a region where a component is attached (for example: the filler neck where the filler pipe is attached) and includes a barrier layer so that it fulfils both a reinforcing function (in this often fragile region) and a waterproofing function. In this variant, the reinforcement is advantageously obtained by compression molding of a multilayer sheet that includes a barrier layer (and preferably a sheet comprising an EVOH layer between two HDPE layers), of a mat of fibers (preferably: continuous, nonwoven and randomly distributed glass fibers) and of an HDPE sheet.

The mechanical strength imparted to the tank base is connected to the type of yarns, to the type of weaving and to the diameter of the yarns used.

The yarns are coated between two films of material, so as to impregnate the free spaces between the yarns and to form a thin layer at the back of the yarns, that is intended to promote their adhesion to the material forming the article to be reinforced.

The material coating the yarns is chosen to be compatible with the injected material forming the wall to be injected. That is to say that the material for impregnating the yarns is capable of intimately binding by fusion with the injected material. A material of the same nature as the material forming the wall will therefore preferably be chosen. In the case that is used to support the present description, a prepreg impregnated with the aid of an HDPE satisfies this condition.

The reinforcing sheet is introduced into the mold at the temperature of the workshop, which is usually between 15° C. and 30° C.

The method according to the invention is therefore based on the fact that the amount of energy needed to melt the material forming the reinforcing sheet is provided by the material injected in the liquid state. This thermal energy therefore comprises at least the portion of energy for increasing the temperature of the reinforcement up to the melting point of the material that forms it, and the energy to be provided for melting this material, so that it mixes, at least over a surface layer, with the injected material.

It is therefore essential to control the various parameters that determine and act with one another to ensure a good bond.

A first factor lies in the choice of the weight of the prepreg, and therefore the thickness thereof. The thinner the prepreg, the lower the amount of energy to be transmitted. For a given requested mechanical strength, a yarn will therefore be selected, the diameter of which is the most appropriate as a function of its cost and its strength. A good compromise for small-capacity tanks is obtained with a prepreg having a total thickness of less than 0.7 mm and preferably less than 0.5 mm.

It will therefore be sought to reduce the thickness of the films used to coat the reinforcing yarns so that the thickness of thermoplastic material at the back of the yarn is less than 0.2 mm and preferably less than 0.05 mm. This value, measured along a direction normal to the surface of the prepreg, corresponds to the smallest thickness of material available between a yarn and said surface.

A second factor to be taken into account is the melting point of the material forming the prepreg which will have to be as low as possible relative to the temperature of the injected material at the moment it is introduced into the mold. It appears in this respect that the difference between the melting point of the thermoplastic material coating the reinforcing yarns and the injection temperature of the thermoplastic material forming said wall should be between 60° C. and 115° C.

The third factor is the temperature for injecting the material into the mold. For processing reasons, this temperature, for an HDPE-type material, is usually between 190° C. and 245° C., and may range up to 280° C. for certain HDPE grades.

For the latter type of material, the melting point of the material coating the yarns of the prepreg will usefully have to be less than 140° C., or even less than 120° C., which is patently compatible with the nature of the materials used. In order to adjust the melting point of the HDPE forming the prepreg, its grade and the length of the polymer chains that form it are adjusted.

The injection temperature may nevertheless reach 330° C. in the case of a material such as PA6 or PPA. The melting point of the material coating the reinforcing yarns of the prepreg may then consequently be adjusted.

The fourth factor regards the cooling capacity of the mold, and consequently the thermal energy that is extracted from the injected material and that cannot be restored to the prepreg. The latter factor is particularly difficult to adjust in that it also determines the demolding temperature and the cycle time of the machine. In the case of HDPE, a temperature below 40° C. makes it possible to obtain an acceptable result, and a temperature of 30° C. constitutes a preferential choice.

However, in the case of material such as PPA, the mold may reach much higher temperatures, of the order of 135° C., or even 140° C., at the moment the prepreg is introduced.

The latter factor also relates to the length of time under pressure, before the opening of the mold. This time depends on the thickness of the injected wall and on the temperature of the mold at the start of the injection. Good results are obtained with a duration under pressure of greater than 0.3 minute and preferably greater than 0.5 minute.

Other factors may also be taken into consideration such as the position of the prepreg relative to the walls of the mold, the capacity and the configuration of the cooling means, or else the thermal inertia of the mold.

A person skilled in the art will usefully be able to implement an experimental design in order to adjust these parameters, and to achieve the best equilibrium for ensuring the fusion of the material forming the prepreg and of the injected material at the interface thereof.

Thus, qualitatively, a relative increase in the thickness of the prepreg will result in a larger thermal energy requirement, which could be satisfied by an increase in the injection temperature or by an increase in the temperature of the mold and in the duration under pressure.

The choice of the melting point of the material forming the prepreg is then consequently adjusted. Alternatively, it is also possible to choose yarns of equivalent strength but of smaller diameter in order to arrive at a thinner thickness.

A perfect bond between the prepreg and the material forming the injected wall is then obtained.

Besides the optimization of the manufacturing process, the fact of introducing the reinforcing sheet directly into the mold at ambient temperature in an injection press makes it possible to simplify the manufacturing process.

This also offers advantages that will be described with reference to FIG. 2, which represents a detailed schematic view of the mold.

Specifically, the absence of plastic deformations and the relative good mechanical strength of the reinforcing sheet at ambient temperature allows a more precise placement of the latter in the injection mold. This also facilitates the handling operations during the introduction with the aid of mechanical transporters for example, in that it is no longer necessary to have to treat the gripping tool in order to prevent the formation of deposits of molten material, as is the case when it is a question of transferring a preheated prepreg into a mold.

Another advantage that it is possible to obtain at lower cost, is the possibility of placing the sheet at a precise distance from each of the internal walls of the mold.

For this purpose, it is possible to have retractable blocks 17 or needles 16 to which the reinforcing sheet 30 is anchored in a precise geometric position. The needles are adjusted to a predetermined height h relative to the internal walls of the mold. This distance h is furthermore not necessarily constant. Several tenths of seconds before the end of the injection of the material, the needles or blocks are then retracted and the final volume of the wall is introduced into the mold and placed under a given setpoint pressure.

The cooling, which occurs by thermal conduction between the walls of the mold and the injected material, will reach the sheet later and will thus enable a better thermal diffusion between the prepreg and the injected material. This embodiment also makes it possible to optimize the strength of the wall as a function of the stresses experienced, in that it becomes possible to place the prepreg at an optimum location relative to the neutral axis of the wall.

FIG. 3 makes it possible to visualize the prepreg 30 after it is put in place on the blocks, just before the closure of the movable platen and injection of the material into the mold.

FIG. 4 illustrates the final result after injection of the portion of the tank base 21 comprising an opening around which said reinforcement 30 is installed.

Another advantage linked to the invention lies in the fact that, when the portion of the wall intended to be reinforced is not a flat or developable surface, it is possible to impart to the prepreg, by any process that is not the subject of the present invention, a given permanent deformation. The reinforcing sheet is then preformed to the final shape that it is desired to give it in the mold. Movements of the material linked to the movements of the reinforcing yarns during the shaping of the sheet in the mold are then prevented from occurring. The geometric features of the molded wall are thereby improved accordingly.

The invention is not limited to the embodiments that are the subject of the present description and other embodiments will be clearly apparent to a person skilled in the art. It is especially possible to vary the nature of the material injected, and all of the information capable of guiding a person skilled in the art in order to produce, by injection, a wall comprising a reinforcement will be found in the preceding explanations.

1. A process for manufacturing a wall, intended for example to form the wall of a tank, by injection, under pressure and at a predetermined temperature, of a thermoplastic material into an injection mold, said wall comprising at least one localized reinforcing sheet of predetermined thickness formed from reinforcing yarns coated with a thermoplastic material that is compatible with the thermoplastic material forming said wall and having a predetermined melting point, wherein the reinforcing sheet is deposited in the injection mold at a temperature substantially equal to the ambient temperature of a workshop and that the injection temperature of the thermoplastic material forming the wall, the melting point of the thermoplastic material coating the reinforcing yarns and the thickness of the reinforcing sheet are adjusted so that the material coating the reinforcing yarns is melted during the injection phase.

2. The manufacturing process as claimed in claim 1, wherein the temperature of the workshop is between 15° C. and 30° C.

3. The manufacturing process as claimed in claim 1, wherein the thermoplastic material forming the wall and the thermoplastic material coating the reinforcing yarns are chosen from materials such as HDPEs, polyamides or polyphthalamides.

4. The manufacturing process as claimed in claim 1, wherein the reinforcing sheet comprises entangled reinforcing yarns.

5. The manufacturing process as claimed in claim 1, wherein the reinforcing sheet comprises one or more sheets of reinforcing yarns, each sheet of reinforcing yarns being composed of reinforcing yarns that are parallel to one another, and the sheets of reinforcing yarns being positioned so that the reinforcing yarns of one sheet form, with the reinforcing yarns of the other sheets, determined and non-zero angles.

6. The manufacturing process as claimed in claim 5, wherein the reinforcing sheet comprises woven reinforcing yarns.

7. The manufacturing process as claimed in claim 1, wherein the thickness of the reinforcing sheet is less than or equal to 0.7 mm, and preferably less than or equal to 0.5 mm.

8. The manufacturing process as claimed claim 1, wherein the reinforcing yarns are embedded between two thermoplastic material films, so that the thickness of the thermoplastic material at the back of the reinforcing yarns is less than or equal to 0.2 mm, and preferably less than or equal to 0.05 mm.

9. The manufacturing process as claimed in claim 1, wherein the difference between the melting point of the thermoplastic material coating the reinforcing yarns of the reinforcing sheet and the injection temperature of the thermoplastic material forming said wall is between 60° C. and 115° C.

10. The manufacturing process as claimed in claim 1, wherein the injection temperature of the thermoplastic material forming said wall is between 190° C. and 330° C.

11. The manufacturing process as claimed in claim 1, wherein a hold time, under pressure, of the material in the mold is greater than 0.3 minute and preferably greater than 0.5 minute.

12. The manufacturing process as claimed in claim 1, wherein a temperature of the mold during the introduction of the reinforcing sheet is between 30° C. and 140° C.

13. The process as claimed in claim 1, wherein the reinforcing sheet is preformed, to the final shape that it is desired to give it in the mold, prior to the introduction thereof into the mold.

14. The manufacturing process as claimed in claim 1, wherein the reinforcing sheet is anchored at a pre-established position in the mold with the aid of a plurality of retractable needles and/or blocks, able to be withdrawn at the end of the phase of injecting the material forming said wall.

15. The process as claimed in claim 14, wherein, prior to the introduction of the reinforcing sheet, a height of the needles and/or blocks is adjusted, so as to position the reinforcing sheet at predefined non-zero distances from the walls of the mold.
